(19) United States
(12) Patent Application Publication
(10) Pub. No.: US 2026/0227812 A1
(43) Pub. Date: Aug. 6, 2026

(54) LEAKAGE CURRENT CONTROL FOR MULTI-SUPPLY VOLTAGE REGULATORS

(71) Applicant: QUALCOMM Incorporated, San Diego, CA (US)

(72) Inventors: Rahul KARMAKER, San Diego, CA (US); Desong ZHAO, San Diego, CA (US)

(21) Appl. No.: 19/043,813

(22) Filed: Feb. 3, 2025

(51) Int. Cl. G05F 1/56; H02J 1/08

(52) U.S. Cl. CPC G05F 1/56; H02J 1/084

(57) ABSTRACT

Techniques and apparatus for supplying power using a power supply circuit, including leakage current control for multi-supply voltage regulators. One example power supply circuit generally includes a first power supply node, a second power supply node, a third power supply node, and an output node. The power supply circuit also generally includes (i) a first head switch transistor including a source coupled to the first power supply node and including a drain coupled to the output node; (ii) a second head switch transistor including a source coupled to the second power supply node and including a drain coupled to the output node; and (iii) a first transistor including a source coupled to the first power supply node, a gate coupled to the third power supply node, and a drain coupled to a gate of the first head switch transistor.

### TECHNICAL FIELD

Certain aspects of the present disclosure generally relate to electronic circuits and, more particularly, to a power supply circuit and techniques for leakage current control.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

Power management integrated circuits (PMICs) are used for managing the power demands of a host system and may include and/or control one or more voltage regulators (e.g., LDOs). A PMIC may be used in battery-operated devices, such as mobile phones, tablets, laptops, wearables, etc., to control the flow and direction of electrical power in the devices. The PMIC may perform a variety of functions for the device such as DC-to-DC conversion, voltage regulation, battery charging, power-source selection, voltage scaling, power sequencing, etc. For example, in a power supply sharing scheme, one or more PMICs may provide multiple power supply voltages, which may be selected between for providing power to another voltage regulator (e.g., an LDO regulator) or other circuit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure provide a power supply circuit. The power supply circuit generally includes a first power supply node, a second power supply node, a third power supply node, and an output node. The power supply circuit also generally includes (i) a first head switch transistor including a source coupled to the first power supply node and including a drain coupled to the output node; (ii) a second head switch transistor including a source coupled to the second power supply node and including a drain coupled to the output node; and (iii) a first transistor including a source coupled to the first power supply node, a gate coupled to the third power supply node, and a drain coupled to a gate of the first head switch transistor.

Certain aspects of the present disclosure are directed to a method of supplying power. The method generally includes (i) turning off a first head switch transistor including a source coupled to a first power supply node and including a drain coupled to an output node and (ii) turning on a second head switch transistor including a source coupled to a second power supply node and including a drain coupled to the output node, where a first transistor ensures a gate of the first head switch transistor is pulled up when turning off the first head switch transistor and where the first transistor includes a source coupled to the first power supply node, a gate coupled to a third power supply node, and a drain coupled to the gate of the first head switch transistor.

Certain aspects of the present disclosure provide a power supply circuit capable of selecting between multiple power supplies for supplying power to a voltage regulator (e.g., a low-dropout (LDO) regulator).

Certain aspects of the present disclosure provide a wireless device including the power supply circuit described herein.

Certain aspects of the present disclosure provide a wearable device including the power supply circuit described herein.

Certain aspects of the present disclosure provide an Internet of Things (IoT) device including the power supply circuit described herein.

Certain aspects of the present disclosure provide an integrated circuit (IC) including the power supply circuit (or at least a portion of the power supply circuit) described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a multi-supply voltage regulator, in which aspects of the present disclosure may be implemented.

FIG. 2 is a block diagram of an example power supply circuit capable of selecting between multiple power supplies for supplying power to a voltage regulator, in accordance with certain aspects of the present disclosure.

FIG. 3A is a circuit diagram of an example power supply circuit capable of selecting between multiple power supplies for supplying power to a voltage regulator, in accordance with certain aspects of the present disclosure.

FIG. 3B is a circuit diagram of an example power selection circuit, in accordance with certain aspects of the present disclosure.

FIG. 3C is a circuit diagram of an example power supply circuit with leakage current control, the power supply circuit being capable of selecting between multiple power supplies for supplying power to a voltage regulator, in accordance with certain aspects of the present disclosure.

FIG. 4 is a flow diagram illustrating example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for leakage current control for multi-supply voltage regulators (e.g., low-dropout (LDO) regulators) using a power supply circuit. Such a power supply circuit may include a first head switch transistor coupled between a first power supply node and an input of a voltage regulator, a second head switch transistor coupled between a second power supply node and the input of a voltage regulator, and a transistor that includes a source coupled to the first power supply node, a gate coupled to a third power supply node, and a drain coupled to a gate of the first head switch transistor. The power supply circuit may utilize the third power supply node (which may be nominally configured to have a higher voltage than the first power supply node and the second power supply node) to minimize (or at least reduce) leakage current through the first head switch transistor or the second head switch transistor during, for example, different transient operating conditions.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

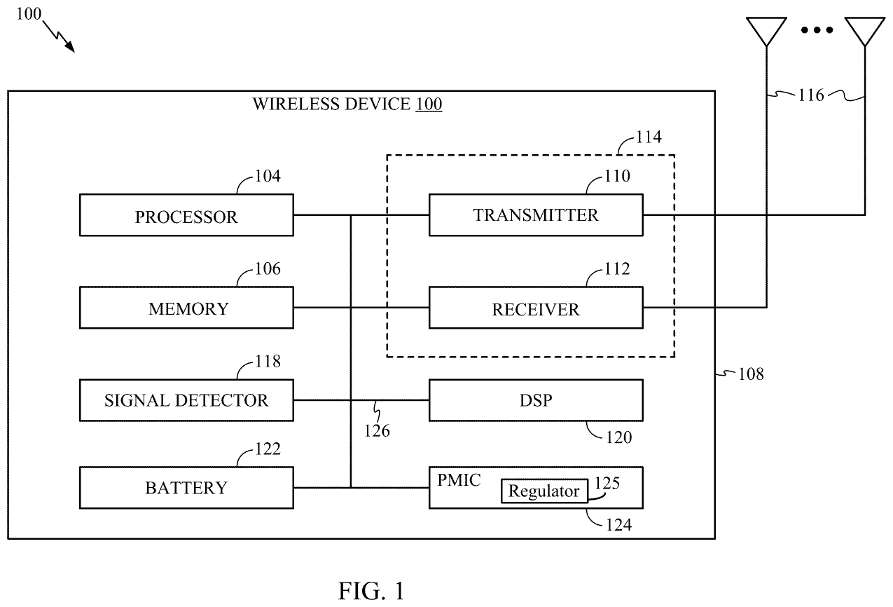

FIG. 1 illustrates an example device 100, in which aspects of the present disclosure may be implemented. The device 100 may be a battery-operated device such as a cellular phone, a personal digital assistant (PDA), a handheld device, a wireless modem, a smartphone, a tablet, a laptop computer, a personal computer, a wearable device, an Internet of Things (IoT) device, an augmented reality device, etc. The device 100 is an example of a device that may be configured to implement the various systems and methods described herein.

The device 100 may include a processor 104 which controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a transmitter 110 and/or a receiver 112 to allow transmission and/or reception, respectively, of data between the device 100 and a remote location. In some cases, the transmitter 110 and receiver 112 may be combined into a transceiver 114. One or more antennas 116 may be attached or otherwise coupled to a housing 108 of the device 100 and electrically coupled to the transceiver 114. For certain aspects, the device 100 may also include multiple transmitters, multiple receivers, and/or multiple transceivers (not shown).

The device 100 may also include a signal detector 118 that may be used in an effort to detect and quantify the level of signals received by the transceiver 114. The signal detector 118 may detect such signals as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 illustrated in FIG. 1 may represent multiple portable power sources, such as a main battery and a backup battery (or a supercapacitor). In some cases, the battery 122 may be rechargeable.

The device 100 may also include a power management integrated circuit (IC) (or PMIC) 124 for managing the power from the battery 122 (or batteries), a wall adapter, and/or a wireless power charger to the various components of the device 100. The PMIC 124 may perform a variety of functions for the device such as DC-to-DC conversion, voltage regulation (e.g., with a voltage regulator 125), battery charging, power-source selection, voltage scaling, power sequencing, etc. In certain aspects, the voltage regulator 125 may receive input power from one of multiple power supplies in a power supply sharing scheme (e.g., a dual-supply LDO or other voltage regulator). In such cases, the voltage regulator 125 may be coupled to or include a power supply circuit with leakage current control, where the power supply circuit is capable of selecting between the different power supplies, as described herein.

The various components of the device 100 may be coupled together by a bus system 126. The bus system 126 may include a power bus, a control signal bus (e.g., system power management interface (SPMI) or inter-integrated circuit (I2C) bus), and/or a status signal bus in addition to a data bus. Additionally or alternatively, various combinations of the components of the device 100 may be coupled together by one or more other suitable techniques.

### Example Power Supply Circuits With Leakage Current Control

In some cases, multiple power supply voltages supplied by one or more power management integrated circuits (PMICs) (e.g., PMIC 124) may be selectively provided to a voltage regulator in a system on a chip (SoC) or other device (e.g., device 100). This scenario may be refererred to as “PMIC sharing.” Selection among the different power supply voltages from the PMIC(s) may depend on the operating condition of the PMIC(s) or the device.

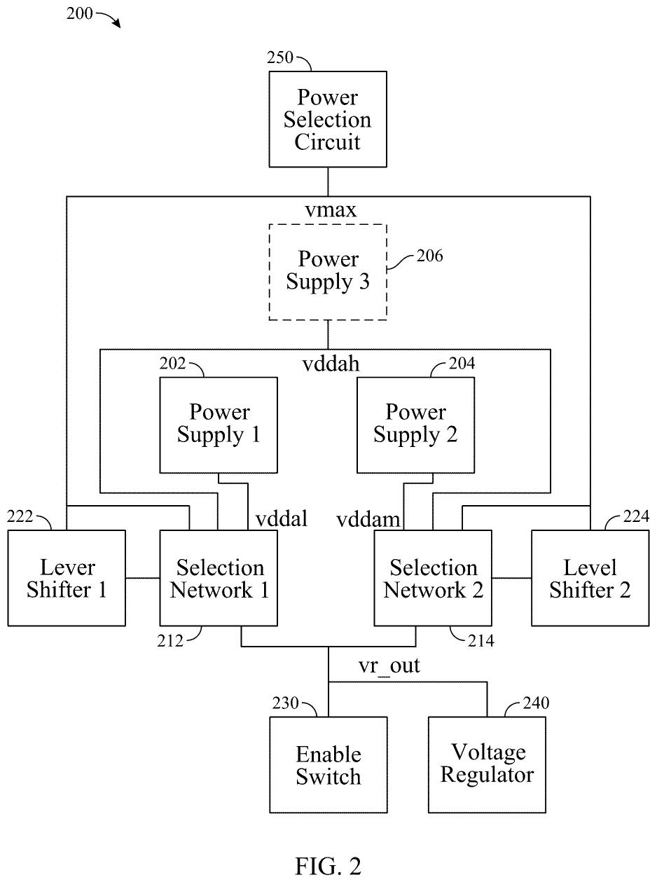

FIG. 2 is a block diagram of an example power supply circuit 200 capable of selecting between multiple power supplies for supplying power to a voltage regulator (e.g., voltage regulator 240), in accordance with certain aspects of the present disclosure. The power supply circuit 200 may include a first power supply 202 (labeled “Power Supply 1”), a second power supply 204 (labeled “Power Supply 2”), a first selection network 212 (labeled “Selection Network 1”), a second selection network 214 (labeled “Selection Network 2”), an enable switch 230, and the voltage regulator 240. The first selection network 212 may be coupled to the first power supply 202 via a power supply node (labeled “vddal”), and the second selection network 214 may be coupled to the second power supply 204 via a power supply node (labeled “vddam”).

The power supply circuit 200 may also include a first level shifter 222 (labeled “Level Shifter 1”) and a second level shifter 224 (labeled “Level Shifter 2”). The first level shifter 222 may receive a first enable input signal (not shown in FIG. 2) and have an output coupled to the first selection network 212, and the second level shifter 224 may receive a second enable input signal (not shown in FIG. 2) and have an output coupled to the second selection network 214.

The power supply circuit 200 may also include a power selection circuit 250 having an output supply sampling node coupled to the first level shifter 222, the second level shifter 224, the first selection network 212, and the second selection network 214. The power selection circuit 250 may be configured to sample the output of the first power supply 202 and the second power supply 204 and output a voltage at the supply sampling node (labeled “vmax”) based on the greater of the two power supply voltages, as described below.

The power supply circuit 200 may be configured to selectively supply (e.g., from the vddal node or the vddam node and through the Selection Network 1 or the Selection Network 2, respectively) a power supply node (labeled “vr_out”) coupled to the voltage regulator 240. The voltage regulator 240 may be implemented, for example, as a low-dropout (LDO) regulator. The first level shifter 222 may be configured to control the first selection network 212, and the second level shifter 224 may be configured to control the second selection network 214 (e.g., to control whether the voltage regulator is supplied from the first power supply 202 via the first selection network 212 or from the second power supply 204 via the second selection network 214). When the power supply circuit 200 is supplying power to the voltage regulator 240, the enable switch 230 may be configured to be open, whereas when the power supply circuit is not supplying power to the voltage regulator 240, the enable switch 230 may be configured to be closed.

The power supply circuit 200 may optionally include a third power supply 206 (labeled “Power Supply 3”) coupled to both the first selection network 212 and the second selection network 214 via a power supply node (labeled “vddah”), as described below. When the third power supply 206 is present, the vddah node may also be input (in addition to the vddal node and the vddam node) to the power selection circuit 250, such that the voltage at the third power supply 206 may be sampled and could be selected as the output of the power selection circuit 250. In certain aspects, the third power supply 206 may be nominally configured to provide a higher output voltage than the first power supply 202 and the second power supply 204.

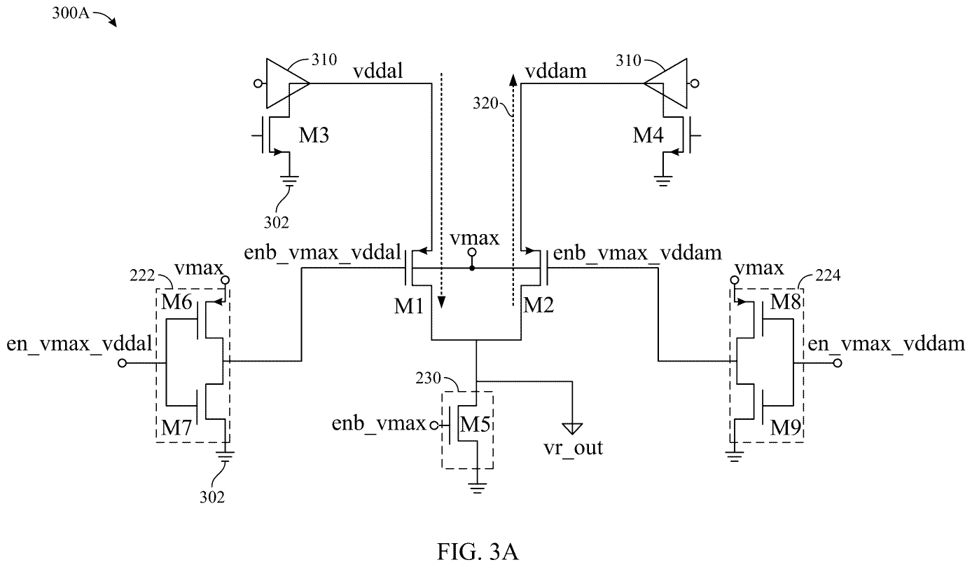

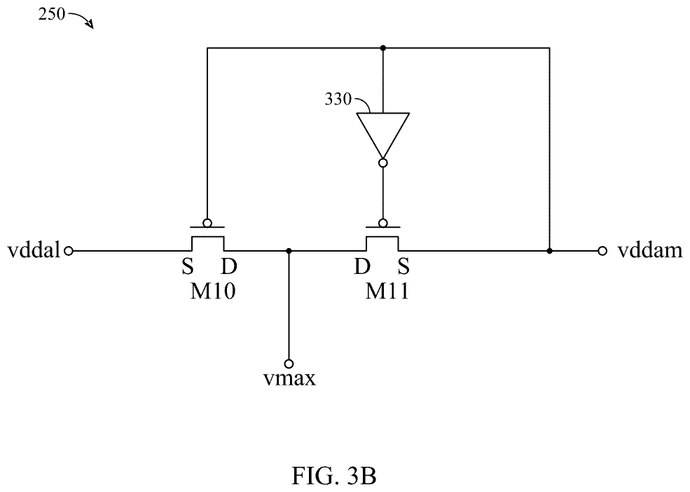

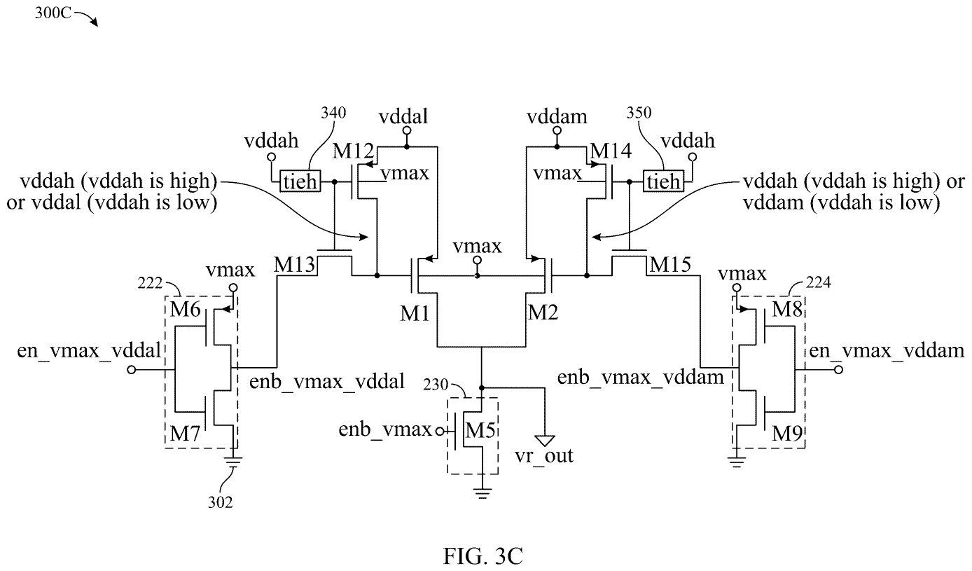

FIG. 3A is a circuit diagram of an example power supply circuit 300A capable of selecting between multiple power supplies for supplying power to a voltage regulator (e.g., voltage regulator 240), in accordance with certain aspects of the present disclosure. The power supply circuit 300A may include transistors M1, M2, M3, and M4, the first level shifter 222, the second level shifter 224, and the enable switch 230. In certain aspects, transistor M1 may be considered as implementing the first selection network 212 of FIG. 2, and transistor M2 may be considered as implementing the second selection network 214 of FIG. 2.

Transistor M1 may include a source coupled to the vddal node, a drain coupled to the vr_out node and the enable switch 230, and a gate coupled to an output of the first level shifter 222. Transistor M2 may include a source coupled to the vddam node, a drain coupled to the vr_out node and the enable switch 230, and a gate coupled to an output of the second level shifter 224. Transistors M1 and M2 may function as and be referred to as head switches (or head switch transistors) of the power supply circuit 300A, and may control whether the voltage regulator coupled to the vr_out node receives power from vddal, from vddam, or neither. In certain aspects, a body of transistor M1 and a body of transistor M2 may be coupled to the vmax node (the supply sampling node). Transistors M1 and M2 may each be implemented by p-type metal-oxide-semiconductor field-effect transistors (MOSFETs).

The vddal node may be coupled to an output of a PMIC 310 (e.g., PMIC 124) and a drain of transistor M3. A source of transistor M3 may be coupled to a reference potential node 302 (e.g., electrical ground) of the power supply circuit 300A. The vddam node may be coupled another output of the PMIC 310 (or the output of a different PMIC) and a drain of transistor M4. A source of transistor M4 may be coupled to the reference potential node 302. Transistors M3 and M4 may each be implemented by n-type MOSFETs. When vddal is not being supplied, transistor M3 may be turned on with an OFF signal being logic high to ground the output of the PMIC 310 (the output of the first power supply 202). When vddam is not being supplied, transistor M4 may be turned on with an OFF signal being logic high to ground the other output of the PMIC 310 or the output of a different PMIC (the output of the second power supply 204).

The enable switch 230 may be implemented by a transistor M5. Transistor M5 may include a drain coupled to the drains of transistors M1 and M2, a gate coupled to a complementary enable node (labeled “enb_vmax”), and a source coupled to the reference potential node 302. Transistor M5 may be implemented by an n-type MOSFET.

The first level shifter 222 may include transistor M6 and transistor M7 (e.g., which form a complementary metal-oxide-semiconductor (CMOS) inverter). Transistor M6 may include a source coupled to the vmax node, a drain coupled to a drain of transistor M7 and to the gate of transistor M1 via a complementary enable node (labeled “enb_vmax_vddal”), and a gate coupled to an enable node (labeled “en_vmax_vddal”). In this manner, the vmax node may be a power supply input of the first level shifter 222. Transistor M7 may include a source coupled to the reference potential node 302 and a gate coupled to the en_vmax_vddal node. Transistor M6 may be implemented by a p-type MOSFET, and transistor M7 may be implemented by an n-type MOSFET.

The first level shifter 222 may be configured to control, based on the en_vmax_vddal node, head switch transistor M1. In some cases, a control signal at the en_vmax_vddal node is logic low, which may result in a control signal at the enb_vmax_vddal node that is pulled up to vmax. In response to the control signal at the enb_vmax_vddal node being pulled up to vmax, transistor M1 may be turned off (e.g., when vmax =vddal). In other cases, the control signal at the en_vmax_vddal node is logic high, which results in the control signal at the enb_vmax_vddal node being low (e.g., pulled to ground). In response to the control signal at the enb_vmax_vddal node being low, transistor M1 may be turned on.

The second level shifter 224 may include transistor M8 and transistor M9. Transistor M8 may include a source coupled to the vmax node, a drain coupled to a drain of transistor M9 and to the gate of transistor M2 via a complementary enable node (labeled “enb_vmax_vddam”), and a gate coupled to an enable node (labeled “en_vmax_vddam”). In this manner, the vmax node may be a power supply input of the second level shifter 224. Transistor M9 may include a source coupled to the reference potential node 302 and a gate coupled to the en_vmax_vddam node. Transistor M8 may be implemented by a p-type MOSFET, and transistor M9 may be implemented by an n-type MOSFET (e.g., forming another CMOS inverter).

The second level shifter 224 may be configured to control, based on the en_vmax_vddam node, head switch transistor M2. In some cases, a control signal at the en_vmax_vddam node is logic low, which may result in a control signal at the enb_vmax_vddam node that is pulled up to vmax. In response to the control signal at the enb_vmax_vddam node being pulled up to vmax, transistor M2 may be turned off (e.g., when vmax =vddam). In other cases, the control signal at the en_vmax_vddam node is logic high, which results in the control signal at the enb_vmax_vddam node being low. In response to the control signal at the enb_vmax_vddam node being low, transistor M2 may be turned on. The first level shifter 222 and the second level shifter 224 may be controlled such that only one of transistor M1 and transistor M2 is turned on at a time, and power may be supplied (e.g., via the vr_out node) to the voltage regulator using the vddal node, the vddam node, or neither.

FIG. 3B is a circuit diagram of an example power selection circuit (e.g., power selection circuit 250), in accordance with certain aspects of the present disclosure. The power selection circuit 250 may include an inverter 330, transistor M10, and transistor M11. Transistor M10 may include a source coupled to the vddal node, a drain coupled to the vmax node, and a gate coupled to the vddam node and to an input of the inverter 330. Transistor M11 may include a source coupled to the vddam node, a drain coupled to the vmax node, and a gate coupled to an output of the inverter 330.

The power selection circuit 250 may be configured to sample the voltages of the power supply nodes (e.g., the voltage at the vddam node and the voltage at the vddal node) and output a voltage at the vmax node equal to whichever of the two sampled voltages is higher. For example, when the voltage at the vddal node is higher than the voltage at the vddam node, the voltage at the vmax node may be equal to the voltage at the vddal node, whereas when the voltage at the vddal node is lower than the voltage at the vddam node, the voltage at the vmax node may be equal to the voltage at the vddam node.

In some cases, the power supply circuit 300A may be operating in a transient supply condition. For example, when changing from supplying vddam to vddal, a voltage at the vddal node may be 0.77 volts, a voltage at the vddam node may be ramping down from 1.2 volts to effectively 0 volts, transistor M1 may be turned on, and transistor M2 should be turned off. Both transistors transistors M3 and M4 may be turned off, at least initially. In these cases, a control signal at the en_vmax_vddal node may be logic high, such that the voltage at the gate of transistor M1 is pulled to ground and transistor M1 is on, and a control signal at the en_vmax_vddam node may be logic low, such that the voltage at the gate of transistor M2 may be equal to a voltage at the vmax node. However, during this transient condition and due to the architecture of the power supply circuit 300A (and the power selection circuit 250), the voltage of the vmax node may lie somewhere between the voltage of the vddal node and the falling voltage of the vddam node. Thus, current leakage 320 may occur from the vddal node to the vddam node (e.g., through the selected head switch transistor M1 and through the forward-biased body diodes of transistor M2), even though transistor M2 should be turned off. Specifically, in these cases, the voltage at the vmax node (e.g., generated by the power selection circuit 250) may be stuck at a mid-voltage level (e.g., less than the voltage at the vddal node (0.77 volts) but greater than the falling voltage at the vddam node) and be insufficient (e.g., too low) to prevent leakage through transistor M2. This leakage scenario can cause latch-up in PMOS transistors and should be prevented. A similar leakage scenario may occur in other transient operating conditions.

Certain aspects of the present disclosure are directed to a power supply circuit that utilizes a third power supply node nominally configured to have a higher voltage than the vddal node and the vddam node to minimize (or at least reduce) leakage current through the head switches of the power supply circuit (e.g., transistors M1 and M2) during, for example, different transient operating conditions.

FIG. 3C is a circuit diagram of an example power supply circuit 300C with leakage current control, in accordance with certain aspects of the present disclosure. The power supply circuit 300C is capable of selecting between multiple power supplies for supplying power to a voltage regulator (e.g., voltage regulator 240). The power supply circuit 300C may be similar to the power supply circuit 300A, and may include transistors M1 and M2, the first level shifter 222 (including transistors M6 and M7), the second level shifter 224 (including transistors M8 and M9), and the enable switch 230 (including transistor M5). However, the power supply circuit 300C may also include the third power supply node (labeled “vddah”) and transistors M12, M13, M14, and M15. The third power supply node may not be configured to supply power to the voltage regulator. That is, the third power supply node may not have an associated head switch for selectively coupling the third power supply node to the vr_out node. In certain aspects, transistors M1, M12, and M13 may be considered as implementing the first selection network 212 of FIG. 2, and transistors M2, M14, and M15 may be considered as implementing the second selection network 214 of FIG. 2.

Transistor M12 may include a source coupled to the vddal node, a gate coupled to the vddah node, and a drain coupled to the gate of transistor M1. Transistor M13 may include a drain coupled to the drain of transistor M12, a source coupled to the output of the first level shifter 222 (e.g., coupled to the drains of transistors M6 and M7), and a gate coupled to the vddah node. In certain aspects, a first buffer circuit 340 (labeled “tieh” and also known as a tie-high cell) may be included and coupled between the vddah node and the gates of transistors M12 and M13.

Transistor M14 may include a source coupled to the vddam node, a gate coupled to the vddah node, and a drain coupled to the gate of transistor M2. Transistor M15 may include a drain coupled to the drain of the transistor M14, a source coupled to an output of the second level shifter 224 (e.g., coupled to the drains of transistors M8 and M9), and a gate coupled to the vddah node. In certain aspects, a second buffer circuit 350 (labeled “tieh”) may be included and coupled between the vddah node and the gates of transistors M14 and M15. The first buffer circuit 340 and/or the second buffer circuit 350 may be configured to buffer the gates of the transistors from (high transient) voltages at the vddah node. In certain aspects, at least one of the first buffer circuit 340 or the second buffer circuit 350 may include or be implemented by a resistive element.

In certain aspects, a body of transistor M12 and a body of transistor M14 may be coupled to the vmax node (the supply sampling node). Transistor M12 may be implemented by a p-type MOSFET, and transistor M13 may be implemented by an n-type MOSFET. Thus, transistors M12 and M13 may effectively form a CMOS inverter. Transistor M14 may be implemented by a p-type MOSFET, and transistor M15 may be implemented by an n-type MOSFET. Thus, transistors M14 and M15 may effectively form another CMOS inverter.

In a first scenario when a voltage at the vddah node is higher than the voltage at the vddal node, transistor M12 may be configured to be off, and transistor M13 may be configured to be on. In this case, transistor M1 may be configured to be off or on based on the control signal at the en_vmax_vddal node. In other words, a voltage at the gate of transistor M1 may be set to the voltage at the vmax node (e.g., as provided by the power selection circuit 250) or to ground. In this scenario, the voltage at the vmax node should ideally be equal to the voltage at the vddah node. In this manner, when the en_vmax_vddal node is logic low, transistor M1 may be fully turned off, and leakage through the body diode of transistor M1 may be minimized (or at least reduced) while transistor M1 is turned off.

In a second scenario when a voltage at the vddah node is higher than the voltage at the vddam node, transistor M14 may be configured to be off, and transistor

M15 may be configured to be on. In this case, transistor M2 may be configured to be off or on based on the control signal at the en_vmax_vddam node. In other words, a voltage at the gate of transistor M2 may be set to the voltage at the vmax node (e.g., as provided by the power selection circuit 250) or to ground. In this scenario, the voltage at the vmax node should ideally be equal to the voltage at the vddah node. In this manner, when the en_vmax_vddam node is logic low, transistor M2 may be fully turned off, and leakage through the body diode of transistor M2 may be minimized (or at least reduced) while transistor M2 is turned off.

In a third scenario when the voltage at the vddah node is lower than the voltage at the vddal node, transistor M12 may be configured to be on, and transistor M13 may be configured to be off. In this case, the source-to-gate voltage of transistor M1 is zero volts, and transitor M1 will be turned off. In other words, the voltage at the drain of transistor M12 may be pulled up to the voltage at the source of transistor M12, such that the voltage at the gate of transistor M1 is equal to the voltage at the vddal node and transistor M1 is fully off with minimal (or at least reduced) leakage.

In a fourth scenario when the voltage at the vddah node is lower than the voltage at the vddam node, transistor M14 may be configured to be on, and transistor M15 may be configured to be off. In this case, the source-to-gate voltage of transistor M2 is zero volts, and transistor M2 will be turned off. In other words, the voltage at the drain of transistor M14 may be pulled up to the voltage at the source of transistor M14, such that the voltage at the gate of transistor M2 is equal to the voltage at the vddam node and transistor M2 is fully off with minimal (or at least reduced) leakage.

### Example Operations for Supplying Power

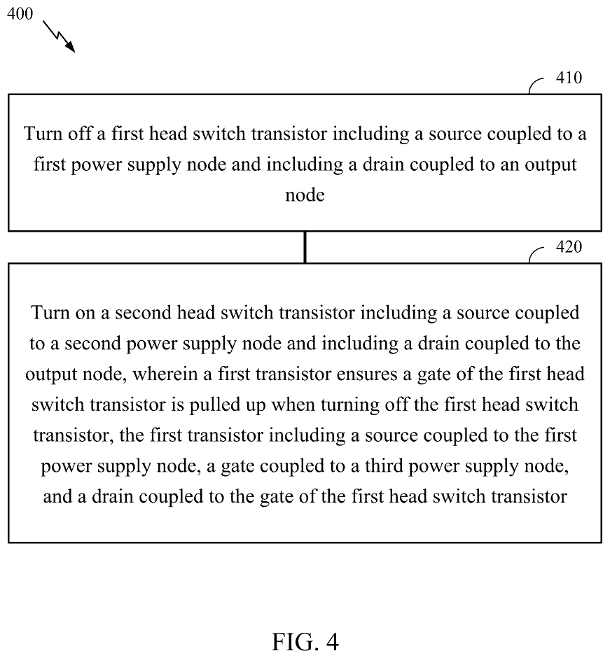

FIG. 4 is a flow diagram illustrating example operations 400 for supplying power, in accordance with certain aspects of the present disclosure. The operations 400 may be performed, for example, by a power supply circuit (e.g., the power supply circuit 300C of FIG. 3C).

The operations 400 may include, at block 410, turning off a first head switch transistor (e.g., transistor M1 or transistor M2) including a source coupled to a first power supply node (e.g., the vddal node or vddam node) and including a drain coupled to an output node (e.g., the vr_out node).

At block 420, the operations 400 may include turning on a second head switch transistor (e.g., transistor M2 or transistor M1) including a source coupled to a second power supply node (e.g., the vddam node or vddal node) and including a drain coupled to the output node. In some cases, a first transistor (e.g., transistor M12 or transistor M14) may ensure that a gate of the first head switch transistor is pulled up when turning off the first head switch transistor. The first transistor may include a source coupled to the first power supply node(a gate coupled to a third power supply node (e.g., the vddah node), and a drain coupled to the gate of the first head switch transistor.

In certain aspects, the third power supply node may be nominally configured to have a higher voltage than the first power supply node and the second power supply node.

According to certain aspects, the operations 400 may further include selecting, for a supply sampling node (e.g., the vmax node), a higher voltage between a first voltage at the first power supply node and a second voltage at the second power supply voltage (e.g., using the power selection circuit 250 of FIGS. 2 and 3B). In these aspects, a body of the first head switch transistor, a body of the second head switch transistor, and a body of the first transistor may be coupled to the supply sampling node.

According to certain aspects, the operations 400 may further include (i) turning off the second head switch transistor (e.g., using the second level shifter 224), and (ii) turning on the first head switch transistor (e.g., using the first level shifter 222). In these aspects, a second transistor (e.g., transistor M14 or transistor M12) may ensure that a gate of the second head switch transistor may be pulled up when turning off the second head switch transistor. The second transistor may include a source coupled to the second power supply node, a gate coupled to the third power supply node, and a drain coupled to the gate of the second head switch transistor.

### EXAMPLE ASPECTS

In addition to the various aspects described above, specific combinations of aspects are within the scope of the disclosure, some of which are detailed below:

Aspect 1: A power supply circuit comprising: a first power supply node; a second power supply node; a third power supply node; an output node; a first head switch

transistor including a source coupled to the first power supply node and including a drain coupled to the output node; a second head switch transistor including a source coupled to the second power supply node and including a drain coupled to the output node; and a first transistor including a source coupled to the first power supply node, a gate coupled to the third power supply node, and a drain coupled to a gate of the first head switch transistor.

Aspect 2: The power supply circuit of Aspect 1, wherein the third power supply node is nominally configured to have a higher voltage than the first power supply node and the second power supply node.

Aspect 3: The power supply circuit of Aspect 1 or 2, further comprising a second transistor including a drain coupled to the drain of the first transistor and a gate coupled to the third power supply node.

Aspect 4: The power supply circuit of Aspect 3, further comprising: a third transistor including a source coupled to the second power supply node, a gate coupled to the third power supply node, and a drain coupled to a gate of the second head switch transistor; and a fourth transistor including a drain coupled to the drain of the third transistor and a gate coupled to the third power supply node.

Aspect 5: The power supply circuit of Aspect 4, wherein a body of the first head switch transistor and a body of the second head switch transistor are coupled to a supply sampling node.

Aspect 6: The power supply circuit of Aspect 5, wherein a body of the first transistor and a body of the third transistor are coupled to the supply sampling node.

Aspect 7: The power supply circuit of Aspect 5 or 6, further comprising: a first level shifter coupled between a first enable node and a source of the second transistor; and a second level shifter coupled between a second enable node and a source of the fourth transistor.

Aspect 8: The power supply circuit of Aspect 7, wherein power supply inputs of the first level shifter and the second level shifter are coupled to the supply sampling node.

Aspect 9: The power supply circuit according to any of Aspects 5-8, further comprising: an inverter; a fifth transistor including a source coupled to the first power supply node, a drain coupled to the supply sampling node, and a gate coupled to the second power supply node and to an input of the inverter; and a sixth transistor including a source coupled to the second power supply node, a drain coupled to the supply sampling node(and a gate coupled to an output of the inverter.

Aspect 10: The power supply circuit according to any of Aspects 4-9, wherein the first transistor comprises a first p-type metal-oxide-semiconductor field-effect transistor (MOSFET), wherein the second transistor comprises a first n-type MOSFET, wherein the third transistor comprises a second p-type MOSFET, and wherein the fourth transistor comprises a second n-type MOSFET.

Aspect 11: The power supply circuit according to any of Aspects 4-10, further comprising: a first buffer circuit coupled between the third power supply node and the gate of the first transistor; and a second buffer circuit coupled between the third power supply node and the gate of the third transistor.

Aspect 12: The power supply circuit of Aspect 11, wherein at least one of the first buffer circuit or the second buffer circuit comprises a resistive element.

Aspect 13: The power supply circuit according to any of Aspects 3-12,wherein when a voltage at the third power supply node is higher than a voltage at the first power supply node, the first transistor is configured to be off, and the second transistor is configured to be on.

Aspect 14: The power supply circuit of Aspect 13, wherein when the voltage at the third power supply node is lower than the voltage at the first power supply node, the first transistor is configured to be on, the second transistor is configured to be off, and the first head switch transistor is configured to be off.

Aspect 15: The power supply circuit according to any of Aspects 1-14, further comprising an enable switch coupled between the output node and a reference potential node of the power supply circuit.

Aspect 16: The power supply circuit according to any of Aspects 1-15, further comprising a voltage regulator, wherein the output node of the power supply circuit is coupled to an input of the voltage regulator.

Aspect 17: A method of supplying power, comprising: turning off a first head switch transistor including a source coupled to a first power supply node and including a drain coupled to an output node; and turning on a second head switch transistor including a source coupled to a second power supply node and including a drain coupled to the output node, wherein a first transistor ensures a gate of the first head switch transistor is pulled up when turning off the first head switch transistor, the first transistor including a source coupled to the first power supply node, a gate coupled to a third power supply node, and a drain coupled to the gate of the first head switch transistor.

Aspect 18: The method of Aspect 17, wherein the third power supply node is nominally configured to have a higher voltage than the first power supply node and the second power supply node.

Aspect 19: The method of Aspect 17 or 18, futher comprising selecting, for a supply sampling node, a higher voltage between a first voltage at the first power supply node and a second voltage at the second power supply voltage, wherein a body of the first head switch transistor, a body of the second head switch transistor, and a body of the first transistor are coupled to the supply sampling node.

Aspect 20: The method according to any of Aspects 17-19, further comprising: turning off the second head switch transistor; and turning on the first head switch transistor, wherein a second transistor ensures a gate of the second head switch transistor is pulled up when turning off the second head switch transistor, the second transistor including a source coupled to the second power supply node, a gate coupled to the third power supply node, and a drain coupled to the gate of the second head switch transistor.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or a processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a first power supply node;
a second power supply node;
a third power supply node;
an output node;
a first head switch transistor including a source coupled to the first power supply node and including a drain coupled to the output node;
a second head switch transistor including a source coupled to the second power supply node and including a drain coupled to the output node; and
a first transistor including a source coupled to the first power supply node, a gate coupled to the third power supply node, and a drain coupled to a gate of the first head switch transistor.

2. The power supply circuit of claim 1, wherein the third power supply node is nominally configured to have a higher voltage than the first power supply node and the second power supply node.

3. The power supply circuit of claim 1, further comprising a second transistor including a drain coupled to the drain of the first transistor and a gate coupled to the third power supply node.

4. The power supply circuit of claim 3, further comprising:
a third transistor including a source coupled to the second power supply node, a gate coupled to the third power supply node, and a drain coupled to a gate of the second head switch transistor; and
a fourth transistor including a drain coupled to the drain of the third transistor and a gate coupled to the third power supply node.

5. The power supply circuit of claim 4, wherein a body of the first head switch transistor and a body of the second head switch transistor are coupled to a supply sampling node.

6. The power supply circuit of claim 5, wherein a body of the first transistor and a body of the third transistor are coupled to the supply sampling node.

7. The power supply circuit of claim 5, further comprising:
a first level shifter coupled between a first enable node and a source of the second transistor; and
a second level shifter coupled between a second enable node and a source of the fourth transistor.

8. The power supply circuit of claim 7, wherein power supply inputs of the first level shifter and the second level shifter are coupled to the supply sampling node.

9. The power supply circuit of claim 5, further comprising:
an inverter;
a fifth transistor including a source coupled to the first power supply node, a drain coupled to the supply sampling node, and a gate coupled to the second power supply node and to an input of the inverter; and
a sixth transistor including a source coupled to the second power supply node, a drain coupled to the supply sampling node, and a gate coupled to an output of the inverter.

10. The power supply circuit of claim 4, wherein the first transistor comprises a first p-type metal-oxide-semiconductor field-effect transistor (MOSFET), wherein the second transistor comprises a first n-type MOSFET, wherein the third transistor comprises a second p-type MOSFET, and wherein the fourth transistor comprises a second n-type MOSFET.

11. The power supply circuit of claim 4, further comprising:
a first buffer circuit coupled between the third power supply node and the gate of the first transistor; and
a second buffer circuit coupled between the third power supply node and the gate of the third transistor.

12. The power supply circuit of claim 11, wherein at least one of the first buffer circuit or the second buffer circuit comprises a resistive element.

13. The power supply circuit of claim 3, wherein when a voltage at the third power supply node is higher than a voltage at the first power supply node, the first transistor is configured to be off, and the second transistor is configured to be on.

14. The power supply circuit of claim 13, wherein when the voltage at the third power supply node is lower than the voltage at the first power supply node, the first transistor is configured to be on, the second transistor is configured to be off, and the first head switch transistor is configured to be off.

15. The power supply circuit of claim 1, further comprising an enable switch coupled between the output node and a reference potential node of the power supply circuit.

16. The power supply circuit of claim 1, further comprising a voltage regulator, wherein the output node of the power supply circuit is coupled to an input of the voltage regulator.

17. A method of supplying power, comprising:
turning off a first head switch transistor including a source coupled to a first power supply node and including a drain coupled to an output node; and
turning on a second head switch transistor including a source coupled to a second power supply node and including a drain coupled to the output node, wherein a first transistor ensures a gate of the first head switch transistor is pulled up when turning off the first head switch transistor, the first transistor including a source coupled to the first power supply node, a gate coupled to a third power supply node, and a drain coupled to the gate of the first head switch transistor.

18. The method of claim 17, wherein the third power supply node is nominally configured to have a higher voltage than the first power supply node and the second power supply node.

19. The method of claim 17, further comprising selecting, for a supply sampling node, a higher voltage between a first voltage at the first power supply node and a second voltage at the second power supply voltage, wherein a body of the first head switch transistor, a body of the second head switch transistor, and a body of the first transistor are coupled to the supply sampling node.

20. The method of claim 17, further comprising:
turning off the second head switch transistor; and
turning on the first head switch transistor, wherein a second transistor ensures a gate of the second head switch transistor is pulled up when turning off the second head switch transistor, the second transistor including a source coupled to the second power supply node, a gate coupled to the third power supply node, and a drain coupled to the gate of the second head switch transistor.
